(19) United States
(12) Patent Application Publication
(10) Pub. No.: US 2006/0094124 A1
(43) Pub. Date: May 4, 2006

(54) Urine sugar meter

(75) Inventors: Narushi Ito, Inagi-shi (JP); Akio Ohashi, Niiza-shi (JP)

Correspondence Address: MCDERMOTT WILL & EMERY LLP, 600 13TH STREET, N.W., WASHINGTON, DC, 20005-3096, US

(73) Assignee: TANITA CORPORATION

(21) Appl. No.: 11/254,735

(22) Filed: Oct. 21, 2005

(30) Foreign Application Priority Data
Nov. 4, 2004 (JP) 2004-320066
Aug. 4, 2005 (JP) 2005-226068

(51) Int. Cl. G01N 31/22; G01N 27/02

(52) U.S. Cl. 436/94; 422/58; 422/68.1

(57) ABSTRACT

A urine sugar meter measures an immediately-before-meal urine sugar value by immediately-before-meal urine sugar measuring means, notifies a subject that an after-meal urine sugar value should be measured after passage of a predetermined time from this measurement by after-meal urine sugar time signal means, measures an after-meal urine sugar value after this notification by after-meal urine sugar measuring means, computes a urine sugar change value X1 which represents the difference between the after-meal urine sugar value and the immediately-before-meal urine sugar value by urine sugar change value computing means, determines acceptability of a change in the amount of sugar in a body based on this computed urine sugar change value by sugar amount change acceptability determining means, and outputs the urine sugar change value and an indicator about the acceptability of the change in the amount of sugar in the body by urine sugar change data output means.

### BACKGROUND OF THE INVENTION

(i) Field of the Invention

This invention relates to a urine sugar meter which measures a high blood sugar level in a body before and after meal.

(ii) Description of the Related Art

As typified by diabetes, the concentration of sugar in the blood or urine becomes high as a body metabolic function with respect to sugar lowers. To treat or prevent diabetes, the body metabolic function with respect to sugar has been examined by measuring a blood sugar level or urine sugar level after passage of a given time after meal by means of a blood sugar meter which measures the concentration of sugar (blood sugar level) in the blood sampled from a subject at the time of its sampling (for example, Patent Publications 1 and 2) or a urine sugar meter which measures the concentration of sugar (urine sugar level) in the urine discharged from a subject at the time of its discharge (for example, Patent Publication 3) and determining acceptability of the body metabolic function with respect to sugar based on the magnitude of the blood sugar value or urine sugar value at the time of its measurement. The reason that the measurement is made after passage of the given time after meal is that the blood sugar level or urine sugar level reaches a peak value approximately after passage of the given time after meal and the body metabolic function with respect to sugar is evaluated based on this peak value.

Patent Publication 1

Japanese Patent Laid-Open Publication No. 2003-334180

Patent Publication 2

Japanese Patent Laid-Open Publication No. 2003-302406

Patent Publication 3

Japanese Patent Laid-Open Publication No. 9-297120

However, since the digestion process and the content of carbohydrates in the intestine vary according to the type of taken meal, the peak times of the blood sugar level and urine sugar level based on the taken meal and the values of the peaks vary. Further, an ability to restore the blood sugar level, i.e., glucose tolerance, differs depending on individuals. Therefore, the blood sugar level does not always reaches the peak value after passage of the given time after meal. Meanwhile, the above conventional blood sugar meter or urine sugar meter measures a blood sugar level or urine sugar level at the time of sampling or discharge thereof.

Accordingly, evaluation of the body metabolic function with respect to sugar by use of the conventional blood sugar meter lacks reliability, because a blood sugar level or urine sugar level measured by the conventional blood sugar meter after passage of a given time after meal (for example, after passage of one hour after meal in the case of the blood sugar meter) is not always a peak value.

Further, to make a highly reliable evaluation by use of the conventional blood sugar meter, a blood sugar level must be measured at short time intervals after meal (for example, at 10-minute intervals after meal) to find its changing trend and the time when the blood sugar level reaches the peak value must be specified. Thus, it was troublesome.

In view of the above circumstances, an object of the present invention is to provide a urine sugar meter which can provide highly reliable result data without much effort in evaluating a body metabolic function with respect to sugar.

### SUMMARY OF THE INVENTION

To achieve the above object, according to one aspect, a urine sugar meter of the present invention comprises:

immediately-before-meal urine sugar measuring means,

after-meal urine sugar time signal means,

after-meal urine sugar measuring means,

urine sugar change value computing means, and

urine sugar change data output means,

wherein

the immediately-before-meal urine sugar measuring means measures an immediately-before-meal urine sugar value,

the after-meal urine sugar time signal means notifies a subject that an after-meal urine sugar value should be measured after passage of a predetermined time from measurement of the immediately-before-meal urine sugar value by the immediately-before-meal urine sugar measuring means,

the after-meal urine sugar measuring means measures the after-meal urine sugar value after notification by the after-meal urine sugar time signal means,

the urine sugar change value computing means computes the difference between the after-meal urine sugar value measured by the after-meal urine sugar measuring means and the immediately-before-meal urine sugar value measured by the immediately-before-meal urine sugar measuring means as a urine sugar change value, and

the urine sugar change data output means outputs the urine sugar change value computed by the urine sugar change value computing means.

Further, according to one form of this aspect, the predetermined time elapsed from measurement of the immediately-before-meal urine sugar value is two hours.

Further, according to another form of this aspect, the urine sugar meter further comprises:

sugar amount change acceptability determining means,

wherein

the sugar amount change acceptability determining means determines acceptability of a change in the amount of sugar in a body based on the urine sugar change value computed by the urine sugar change value computing means, and

the urine sugar change data output means also outputs an indicator about the acceptability of the change in the amount of sugar in the body determined by the sugar amount change acceptability determining means.

Further, according to another form of this aspect, the sugar amount change acceptability determining means determines that the change in the amount of sugar in the body is “good” which means “acceptable” when the urine sugar change value is not larger than 20 mg/dl, “slightly high” which means “unacceptable” when the urine sugar change value is larger than 20 mg/dl but not larger than 50 mg/dl and “high” which means “unacceptable” when the urine sugar change value is larger than 50 mg/dl.

Further, according to another form of this aspect, the after-meal urine sugar time signal means also notifies the subject that the after-meal urine sugar value should be remeasured after passage of a predetermined time from measurement of the after-meal urine sugar value by the after-meal urine sugar measuring means, when the change in the amount of sugar in the body which has been determined by the sugar amount change acceptability determining means is unacceptable.

Further, according to another form of this aspect, the predetermined time elapsed from measurement of the after-meal urine sugar value is one hour.

Further, according to another form of this aspect, the urine sugar meter further comprises:

before-meal urine sugar measuring means, and

immediately-before-meal urine sugar time signal means,

wherein

the before-meal urine sugar measuring means measures a before-meal urine sugar value before measurement of the immediately-before-meal urine sugar value by the immediately-before-meal urine sugar measuring means, and

the immediately-before-meal urine sugar time signal means notifies the subject that the immediately-before-meal urine sugar value should be measured after passage of a predetermined time from measurement of the before-meal urine sugar value by the before-meal urine sugar measuring means.

Further, according to another form of this aspect, the predetermined time elapsed from measurement of the before-meal urine sugar value is one hour.

Further, according to another aspect, a urine sugar meter of the present invention comprises:

immediately-before-reference-meal urine sugar measuring means,

after-reference-meal urine sugar time signal means,

after-reference-meal urine sugar measuring means,

reference urine sugar change value computing means,

immediately-before-normal-meal urine sugar measuring means,

after-normal-meal urine sugar time signal means,

after-normal-meal urine sugar measuring means,

normal urine sugar change value computing means,

meal difference urine sugar change value computing means, and

meal difference urine sugar change data output means,

wherein

the immediately-before-reference-meal urine sugar measuring means measures an immediately-before-reference-meal urine sugar value,

the after-reference-meal urine sugar time signal means notifies a subject that an after-reference-meal urine sugar value should be measured after passage of a predetermined time from measurement of the immediately-before-reference-meal urine sugar value by the immediately-before-reference-meal urine sugar measuring means,

the after-reference-meal urine sugar measuring means measures the after-reference-meal urine sugar value after notification by the after-reference-meal urine sugar time signal means,

the reference urine sugar change value computing means computes the difference between the after-reference-meal urine sugar value measured by the after-reference-meal urine sugar measuring means and the immediately-before-reference-meal urine sugar value measured by the immediately-before-reference-meal urine sugar measuring means as a reference urine sugar change value,

the immediately-before-normal-meal urine sugar measuring means measures an immediately-before-normal-meal urine sugar value,

the after-normal-meal urine sugar time signal means notifies the subject that an after-normal-meal urine sugar value should be measured after passage of a predetermined time from measurement of the immediately-before-normal-meal urine sugar value by the immediately-before-normal-meal urine sugar measuring means,

the after-normal-meal urine sugar measuring means measures the after-normal-meal urine sugar value after notification by the after-normal-meal urine sugar time signal means,

the normal urine sugar change value computing means computes the difference between the after-normal-meal urine sugar value measured by the after-normal-meal urine sugar measuring means and the immediately-before-normal-meal urine sugar value measured by the immediately-before-normal-meal urine sugar measuring means as a normal urine sugar change value,

the meal difference urine sugar change value computing means computes the difference between the normal urine sugar change value computed by the normal urine sugar change value computing means and the reference urine sugar change value computed by the reference urine sugar change value computing means as a meal difference urine sugar change value, and

the meal difference urine sugar change data output means outputs the meal difference urine sugar change value computed by the meal difference urine sugar change value computing means.

Further, according to one form of this aspect, the predetermined time elapsed from measurement of the immediately-before-reference-meal urine sugar value is two hours, and the predetermined time elapsed from measurement of the immediately-before-normal-meal urine sugar value is two hours.

Further, according to another form of this aspect, the urine sugar meter further comprises:

meal menu acceptability determining means,

wherein

the meal menu acceptability determining means determines acceptability of a normal meal menu based on the meal difference urine sugar change value computed by the meal difference urine sugar change value computing means, and

the meal difference urine sugar change data output means also outputs an indicator about the acceptability of the normal meal menu determined by the meal menu acceptability determining means.

Further, according to another form of this aspect, the meal menu acceptability determining means determines that the normal meal menu is “small” which means “acceptable” when the meal difference urine sugar change value is smaller than −50 mg/dl, “equivalent” which means “unacceptable” when the meal difference urine sugar change value is not smaller than −50 mg/dl and not larger than 50 mg/dl and “large” which means “unacceptable” when the meal difference urine sugar change value is larger than 50 mg/dl.

Further, according to another form of this aspect, the urine sugar meter further comprises:

before-reference-meal urine sugar measuring means, immediately-before-reference-meal urine sugar time signal means, before-normal-meal urine sugar measuring means, and immediately-before-normal-meal urine sugar time signal means,

wherein

the before-reference-meal urine sugar measuring means measures a before-reference-meal urine sugar value before measurement of the immediately-before-reference-meal urine sugar value by the immediately-before-reference-meal urine sugar measuring means, the immediately-before-reference-meal urine sugar time signal means notifies the subject that the immediately-before-reference-meal urine sugar value should be measured after passage of a predetermined time from measurement of the before-reference-meal urine sugar value by the before-reference-meal urine sugar measuring means,

the before-normal-meal urine sugar measuring means measures a before-normal-meal urine sugar value before measurement of the immediately-before-normal-meal urine sugar value by the immediately-before-normal-meal urine sugar measuring means, and the immediately-before-normal-meal urine sugar time signal means notifies the subject that the immediately-before-normal-meal urine sugar value should be measured after passage of a predetermined time from measurement of the before-normal-meal urine sugar value by the before-normal-meal urine sugar measuring means.

Further, according to another form of this aspect, the predetermined time elapsed from measurement of the before-reference-meal urine sugar value is one hour, and the predetermined time elapsed from measurement of the before-normal-meal urine sugar value is one hour.

A urine sugar meter of the present invention measures an immediately-before-meal urine sugar value by immediately-before-meal urine sugar measuring means, notifies a subject that an after-meal urine sugar value should be measured after passage of a predetermined time (preferably 2 hours) by after-meal urine sugar time signal means, measures the after-meal urine sugar value by after-meal urine sugar measuring means, computes a urine sugar change value which represents the difference between the after-meal urine sugar value and the immediately-before-meal urine sugar value by urine sugar change value computing means, and outputs the urine sugar change value by urine sugar change data output means. Thus, the measurement is carried out only immediately before meal and after meal. Further, a high blood sugar level which occurs in the blood based on taken meal is reflected on a urine sugar change value obtained by measurement after passage of a predetermined time by discharging urine collected in the bladder in immediately-before-meal measurement. In other words, most of sugar which is not used in a body after meal can be secured due to an insufficient body metabolic function.

Further, after passage of two hours from measurement of the immediately-before-meal urine sugar value, sugar that is not used in the body after meal is discharged into the urine and is hardly diluted by an increase of the urine. Thus, the subject can be provided with a more reliable urine sugar change value.

Further, by determining acceptability of a change in the amount of sugar in the body by sugar amount change acceptability determining means and outputting an indicator thereabout by urine sugar change data output means, the subject can be provided with the result of determination of body metabolic function with respect to sugar without effort.

Further, by determining the acceptability of the change in the amount of sugar in the body to be “good” when the urine sugar change value is not larger than 20 mg/dl, “slightly high” when the urine sugar change value is larger than 20 mg/dl but not larger than 50 mg/dl and “high” when the urine sugar change value is larger than 50 mg/dl, the subject can be provided with a more advantageous result of determination of the body metabolic function with respect to sugar.

Further, by notifying the subject that the after-meal urine sugar value should be measured after passage of a predetermined time (preferably 1 hour) by after-meal urine sugar time signal means when the result of determination of the change in the amount of sugar in the body is unacceptable, the subject can be provided with the urine sugar change value and the result of determination of the body metabolic function with respect to sugar continuously.

Further, the point when one hour is elapsed from measurement of the after-meal urine sugar value is suited for collection of urine and evaluation intervals. Thus, the subject can be provided with the urine sugar change value and the result of determination of the body metabolic function with respect to sugar continuously without much burden.

Further, by measuring a before-meal urine sugar value by before-meal urine sugar measuring means and notifying the subject that an immediately-before-meal urine sugar value should be measured after passage of a predetermined time (preferably one hour) by immediately-before-meal urine sugar time signal means, the subject can be provided with an accurate immediately-before-meal urine sugar value.

Further, the point when one hour is elapsed from measurement of the before-meal urine sugar value is suited for collection of urine. Thus, the subject can be provided with the immediately-before-meal urine sugar value accurately without much burden.

Further, a urine sugar meter of the present invention measures an immediately-before-reference-meal urine sugar value by immediately-before-reference-meal urine sugar measuring means, notifies a subject that an after-reference-meal urine sugar value should be measured after passage of a predetermined time (preferably two hours) by after-reference-meal urine sugar time signal means, measures the after-reference-meal urine sugar value by after-reference-meal urine sugar measuring means, computes a reference urine sugar change value which represents the difference between the after-reference-meal urine sugar value and the immediately-before-reference-meal urine sugar value by reference urine sugar change value computing means, measures an immediately-before-normal-meal urine sugar value by immediately-before-normal-meal urine sugar measuring means, notifies the subject that an after-normal-meal urine sugar value should be measured after passage of a predetermined time (preferably two hours) by after-normal-meal urine sugar time signal means, measures the after-normal-meal urine sugar value by after-normal-meal urine sugar measuring means, computes a normal urine sugar change value which represents the difference between the after-normal-meal urine sugar value and the immediately-before-normal-meal urine sugar value by normal urine sugar change value computing means, computes a meal difference urine sugar change value which represents the difference between the normal urine sugar change value and the reference urine sugar change value by meal difference urine sugar change value computing means, and outputs the meal difference urine sugar change value by meal difference urine sugar change data output means. According to this urine sugar meter, the subject can be provided with a highly reliable meal difference urine sugar change value based on a difference in the menu of meal to be taken.

Further, after passage of two hours from measurement of the immediately-before-reference-meal urine sugar value and after passage of two hours from measurement of the immediately-before-normal-meal urine sugar value, sugar that is not used in the body after meal is discharged into the urine and is hardly diluted by an increase of the urine. Thus, the subject can be provided with a more reliable meal difference urine sugar change value.

Further, by determining acceptability of a normal meal menu by meal menu acceptability determining means and outputting an indicator thereabout by the meal difference urine sugar change data output means, the subject can be provided with the result of determination of the meal menu without much effort.

Further, by determining the acceptability of the normal meal menu to be “small” when the meal difference urine sugar change value is smaller than −50 mg/dl, “equivalent” when the meal difference urine sugar change value is not smaller than −50 mg/dl and not larger than 50 mg/dl and “large” when the meal difference urine sugar change value is larger than 50 mg/dl, the subject can be provided with a more advantageous result of determination of the meal menu.

Further, by measuring a before-reference-meal urine sugar value by before-reference-meal urine sugar measuring means, notifying the subject that an immediately-before-reference-meal urine sugar value after passage of a predetermined time (preferably one hour) by immediately-before-reference-meal urine sugar time signal means, measuring a before-normal-meal urine sugar value by before-normal-meal urine sugar measuring means and notifying the subject that an immediately-before-normal-meal urine sugar value should be measured after passage of a predetermined time (preferably one hour) by immediately-before-normal-meal urine sugar time signal means, the subject can be provided with the immediately-before-reference-meal urine sugar value and the before-normal-meal urine sugar value accurately.

Further, the point when one hour is elapsed from measurement of the before-reference-meal urine sugar value and the point when one hour is elapsed from measurement of the before-normal-meal urine sugar value are suited for collection of urine. Thus, the subject can be provided with an accurate immediately-before-reference-meal urine sugar value and an accurate before-normal-meal urine sugar value without much burden.

### BRIEF DESCRIPTION OF THE DRAWINGS

FIG. 1 is an external view of a urine sugar meter according to the present invention in a detached state.

FIG. 2 is an external view of the urine sugar meter according to the present invention in a stored state.

FIG. 3 is a block diagram illustrating the constitution of the urine sugar meter according to the present invention.

FIG. 4 is a diagram illustrating the display form of the display section in FIG. 1.

FIG. 5 is a main flowchart illustrating procedures about the handling and operation of the urine sugar meter according to the present invention.

FIG. 6 is a subroutine flowchart illustrating procedures about the handling and operation of the urine sugar meter according to the present invention.

FIG. 7 is a diagram illustrating measuring urine in a toilet.

FIG. 8 is a diagram illustrating measuring urine in a container.

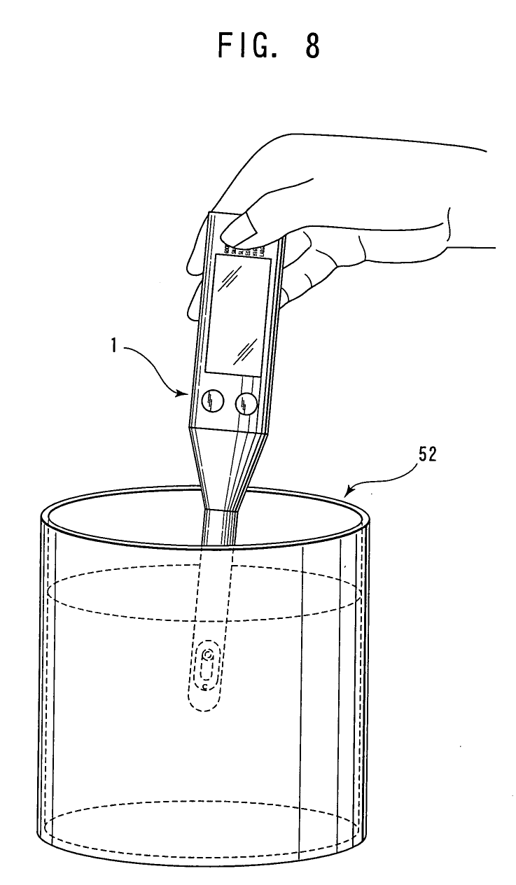

### DETAILED DESCRIPTION OF THE PREFERRED EMBODIMENTS

The urine sugar meter of the present invention has two event mode functions. To achieve one of the event mode functions, the urine sugar meter comprises before-meal urine sugar measuring means, immediately-before-meal urine sugar time signal means, immediately-before-meal urine sugar measuring means, after-meal urine sugar time signal means, after-meal urine sugar measuring means, urine sugar change value computing means, sugar amount change acceptability determining means, and urine sugar change data output means. Further, to achieve the other event mode function, the urine sugar meter comprises before-reference-meal urine sugar measuring means, immediately-before-reference-meal urine sugar time signal means, immediately-before-reference-meal urine sugar measuring means, after-reference-meal urine sugar time signal means, after-reference-meal urine sugar measuring means, reference urine sugar change value computing means, before-normal-meal urine sugar measuring means, immediately-before-normal-meal urine sugar time signal means, immediately-before-normal-meal urine sugar measuring means, after-normal-meal urine sugar time signal means, after-normal-meal urine sugar measuring means, normal urine sugar change value computing means, meal difference urine sugar change value computing means, meal menu acceptability determining means, and meal difference urine sugar change data output means.

The reference meal refers to a meal (for example, a meal having a balance among carbohydrates, proteins and fats and a total calorie controlled for a subject) suited for treating or preventing diabetes based on instructions provided by professionals (such as doctors and nutritionists) or literatures (such as recipe books for treating or preventing diabetes). The normal meal refers to a meal which is taken by a subject on a daily basis.

First, each of the means for achieving one event mode function (a function for measuring a urine sugar change value between before and after meal and determining a change in the amount of sugar in a body) will be described in detail.

The before-meal urine sugar measuring means measures a before-meal urine sugar value before measurement of an immediately-before-meal urine sugar value by the immediately-before-meal urine sugar measuring means. This is means for eliminating the influence of sugar component discharged and remaining in the urine after the last meal.

The immediately-before-meal urine sugar time signal means notifies a subject that the immediately-before-meal urine sugar value should be measured after a predetermined time is elapsed from measurement of the before-meal urine sugar value by the before-meal urine sugar measuring means. The predetermined time refers to a time suited for collecting urine to be examined until immediately before meal. The predetermined time is preferably one hour.

The immediately-before-meal urine sugar measuring means measures the immediately-before-meal urine sugar value. This is means for acquiring a urine sugar value which serves as a reference for determining a urine sugar change value.

The after-meal urine sugar time signal means notifies the subject that an after-meal urine sugar value should be measured after a predetermined time is elapsed from measurement of the immediately-before-meal urine sugar value by the immediately-before-meal urine sugar measuring means. The predetermined time refers to a time during which sugar that is not used in the body after meal is discharged into the urine and hardly diluted by an increase of the urine, i.e., a time suited for collecting urine to be examined. The predetermined time is preferably two hours.

The after-meal urine sugar measuring means measures the after-meal urine sugar value after notification by the after-meal urine sugar time signal means. This is means for acquiring a urine sugar value which is used to determine the urine sugar change value.

The urine sugar change value computing means computes, as the urine sugar change value, the difference between the after-meal urine sugar value measured by the after-meal urine sugar measuring means and the immediately-before-meal urine sugar value measured by the immediately-before-meal urine sugar measuring means. This is means for determining the amount of sugar which is not used in the body after meal due to an insufficient body metabolic function.

The sugar amount change acceptability determining means determines acceptability of a change in the amount of sugar in the body based on the urine sugar change value computed by the urine sugar change value computing means. This is means for automatically determining the amount of sugar which is not used in the body after meal due to an insufficient body metabolic function. The acceptability of the change in the amount of sugar in the body is desirably determined to be “good” when the urine sugar change value is not larger than 20 mg/dl, “slightly high” when the urine sugar change value is larger than 20 mg/dl but not larger than 50 mg/dl and “high” when the urine sugar change value is larger than 50 mg/dl. This is because it is a determination range suited for determining diseases such as diabetes and arteriosclerosis and prevention of the diseases.

The urine sugar change data output means outputs the urine sugar change value computed by the urine sugar change value computing means and an indicator about the acceptability of the change in the amount of sugar in the body which has been determined by the sugar amount change acceptability determining means. This is means for providing the subject with the results.

According to the above constitution, the urine sugar meter measures a before-meal urine sugar value by the before-meal urine sugar measuring means, notifies a subject that an immediately-before-meal urine sugar value should be measured after a predetermined time (preferably one hour) is elapsed from measurement of the before-meal urine sugar value by the immediately-before-meal urine sugar time signal means, measures the immediately-before-meal urine sugar value after the notification by the immediately-before-meal urine sugar measuring means, notifies the subject that an after-meal urine sugar value should be measured after a predetermined time (preferably two hours) is elapsed from measurement of the immediately-before-meal urine sugar value by the after-meal urine sugar time signal means, measures the after-meal urine sugar value after the notification by the after-meal urine sugar measuring means, computes a urine sugar change value which represents the difference between the after-meal urine sugar value and the immediately-before-meal urine sugar value by the urine sugar change value computing means, determines acceptability of a change in the amount of sugar in the body based on the computed urine sugar change value (preferably determines it to be “good” when the urine sugar change value is not larger than 20 mg/dl, “slightly high” when the urine sugar change value is larger than 20 mg/dl but not larger than 50 mg/dl and “high” when the urine sugar change value is larger than 50 mg/dl) by the sugar amount change acceptability determining means, outputs the urine sugar change value and an indicator about the acceptability of the change in the amount of sugar in the body by the urine sugar change data output means, and notifies the subject that the after-meal urine sugar value should be measured after a predetermined time (preferably one hour) is elapsed from measurement of the after-meal urine sugar value when the determined change in the amount of sugar in the body is not acceptable by the after-meal urine sugar time signal means. Therefore, the subject can be provided with a highly reliable urine sugar change value and a highly reliable result of determination of body metabolic function with respect to sugar accurately and without much effort.

Next, each of the means for achieving the other event mode function (a function for determining a meal difference urine sugar change value between a reference meal and a normal meal and determining acceptability of the normal meal) will be described in detail.

The before-reference-meal urine sugar measuring means measures a before-reference-meal urine sugar value before measurement of an immediately-before-meal urine sugar value by the immediately-before-reference-meal urine sugar measuring means. This is means for eliminating the influence of sugar component discharged and remaining in the urine after the last meal.

The immediately-before-reference-meal urine sugar time signal means notifies a subject that the immediately-before-reference-meal urine sugar value should be measured after a predetermined time is elapsed from measurement of the before-reference-meal urine sugar value by the before-reference-meal urine sugar measuring means. The predetermined time refers to a time suited for collecting urine to be examined until immediately before reference meal. The predetermined time is preferably one hour.

The immediately-before-reference-meal urine sugar measuring means measures the immediately-before-reference-meal urine sugar value. This is means for acquiring a urine sugar value which serves as a reference for determining a reference urine sugar change value.

The after-reference-meal urine sugar time signal means notifies the subject that an after-reference-meal urine sugar value should be measured after a predetermined time is elapsed from measurement of the immediately-before-reference-meal urine sugar value by the immediately-before-reference-meal urine sugar measuring means. The predetermined time refers to a time during which sugar that is not used in the body after the reference meal is discharged into the urine and hardly diluted by an increase of the urine, i.e., a time suited for collecting urine to be examined. The predetermined time is preferably two hours.

The after-reference-meal urine sugar measuring means measures the after-reference-meal urine sugar value after notification by the after-reference-meal urine sugar time signal means. This is means for acquiring a urine sugar value which is used to determine the reference urine sugar change value.

The reference urine sugar change value computing means computes, as the reference urine sugar change value, the difference between the after-reference-meal urine sugar value measured by the after-reference-meal urine sugar measuring means and the immediately-before-reference-meal urine sugar value measured by the immediately-before-reference-meal urine sugar measuring means. This is means for determining the amount of sugar which is not used in the body after the reference meal due to an insufficient body metabolic function.

The before-normal-meal urine sugar measuring means measures a before-normal-meal urine sugar value before measurement of an immediately-before-meal urine sugar value by the immediately-before-normal-meal urine sugar measuring means. This is means for eliminating the influence of sugar component discharged and remaining in the urine after the last meal.

The immediately-before-normal-meal urine sugar time signal means notifies a subject that the immediately-before-normal-meal urine sugar value should be measured after a predetermined time is elapsed from measurement of the before-normal-meal urine sugar value by the before-normal-meal urine sugar measuring means. The predetermined time refers to a time suited for collecting urine to be examined until immediately before normal meal. The predetermined time is preferably one hour.

The immediately-before-normal-meal urine sugar measuring means measures the immediately-before-normal-meal urine sugar value. This is means for acquiring a urine sugar value which serves as a reference for determining a normal urine sugar change value.

The after-normal-meal urine sugar time signal means notifies the subject that an after-normal-meal urine sugar value should be measured after a predetermined time is elapsed from measurement of the immediately-before-normal-meal urine sugar value by the immediately-before-normal-meal urine sugar measuring means. The predetermined time refers to a time during which sugar that is not used in the body after the normal meal is discharged into the urine and hardly diluted by an increase of the urine, i.e., a time suited for collecting urine to be examined. The predetermined time is preferably two hours.

The after-normal-meal urine sugar measuring means measures the after-normal-meal urine sugar value after notification by the after-normal-meal urine sugar time signal means. This is means for acquiring a urine sugar value which is used to determine the normal urine sugar change value.

The normal urine sugar change value computing means computes, as the normal urine sugar change value, the difference between the after-normal-meal urine sugar value measured by the after-normal-meal urine sugar measuring means and the immediately-before-normal-meal urine sugar value measured by the immediately-before-normal-meal urine sugar measuring means. This is means for determining the amount of sugar which is not used in the body after the normal meal due to an insufficient body metabolic function.

The meal difference urine sugar change value computing means computes, as a meal difference urine sugar change value, the difference between the normal urine sugar change value computed by the normal urine sugar change value computing means and the reference urine sugar change value computed by the reference urine sugar change value computing means. This is means for determining the amount of sugar that is not used in the body based on a difference in the menus of taken meals.

The meal menu acceptability determining means determines acceptability of the normal meal menu based on the meal difference urine sugar change value computed by the meal difference urine sugar change value computing means. This is means for automatically determining the amount of sugar which is not used in the body based on a difference in the menus of taken meals. The acceptability of the normal meal menu is desirably determined to be “small” when the meal difference urine sugar change value is smaller than −50 mg/dl, “equivalent” when the meal difference urine sugar change value is not smaller than −50 mg/dl and not larger than 50 mg/dl and “large” when the meal difference urine sugar change value is larger than 50 mg/dl. This is because it is a determination range suited for determining adequacy of normal meals taken by those who have diseases such as diabetes and arteriosclerosis and those who try to prevent having such diseases.

The meal difference urine sugar change data output means outputs the meal difference urine sugar change value computed by the meal difference urine sugar change value computing means and an indicator about the acceptability of the normal meal menu determined by the meal menu acceptability determining means. This is means for providing the subject with the results.

According to the above constitution, the urine sugar meter measures a before-reference-meal urine sugar value by the before-reference-meal urine sugar measuring means, notifies a subject that an immediately-before-reference-meal urine sugar value should be measured after a predetermined time (preferably one hour) is elapsed from measurement of the before-reference-meal urine sugar value by the immediately-before-reference-meal urine sugar time signal means, measures the immediately-before-reference-meal urine sugar value after the notification by the immediately-before-reference-meal urine sugar measuring means, notifies the subject that an after-reference-meal urine sugar value should be measured after a predetermined time (preferably two hours) is elapsed from measurement of the immediately-before-reference-meal urine sugar value by the after-reference-meal urine sugar time signal means, measures the after-reference-meal urine sugar value after the notification by the after-reference-meal urine sugar measuring means, computes a reference urine sugar change value which represents the difference between the after-reference-meal urine sugar value and the immediately-before-reference-meal urine sugar value by the reference urine sugar change value computing means, measures a before-normal-meal urine sugar value by the before-normal-meal urine sugar measuring means, notifies the subject that an immediately-before-normal-meal urine sugar value should be measured after a predetermined time (preferably one hour) is elapsed from measurement of the before-normal-meal urine sugar value by the immediately-before-normal-meal urine sugar time signal means, measures the immediately-before-normal-meal urine sugar value after the notification by the immediately-before-normal-meal urine sugar measuring means, notifies the subject that an after-normal-meal urine sugar value should be measured after a predetermined time (preferably two hours) is elapsed from measurement of the immediately-before-normal-meal urine sugar value by the after-normal-meal urine sugar time signal means, measures the after-normal-meal urine sugar value after the notification by the after-normal-meal urine sugar measuring means, computes a normal urine sugar change value which represents the difference between the after-normal-meal urine sugar value and the immediately-before-normal-meal urine sugar value by the normal urine sugar change value computing means, computes a meal difference urine sugar change value which represents the difference between the normal urine sugar change value and the reference urine sugar change value by the meal difference urine sugar change value computing means, determines acceptability of a normal meal menu based on the computed meal difference urine sugar change value (preferably determines it to be “small” when the meal difference urine sugar change value is smaller than −50 mg/dl, “equivalent” when the meal difference urine sugar change value is not smaller than −50 mg/dl and not larger than 50 mg/dl and “large” when the meal difference urine sugar change value is larger than 50 mg/dl) by the meal menu acceptability determining means, and outputs the meal difference urine sugar change value and an indicator about the acceptability of the normal meal menu by the meal difference urine sugar change data output means. Thus, the subject can be provided with a highly reliable meal difference urine sugar change value and a highly reliable result of determination of a meal menu accurately and without much effort.

Hereinafter, the above forms will be further described by use of, as an embodiment, a urine sugar meter which has a urine sugar sensor capable of detecting not only urine sugar of medium to high concentration range but also urine sugar of low concentration range which has been difficult to detect accurately.

### EXAMPLES

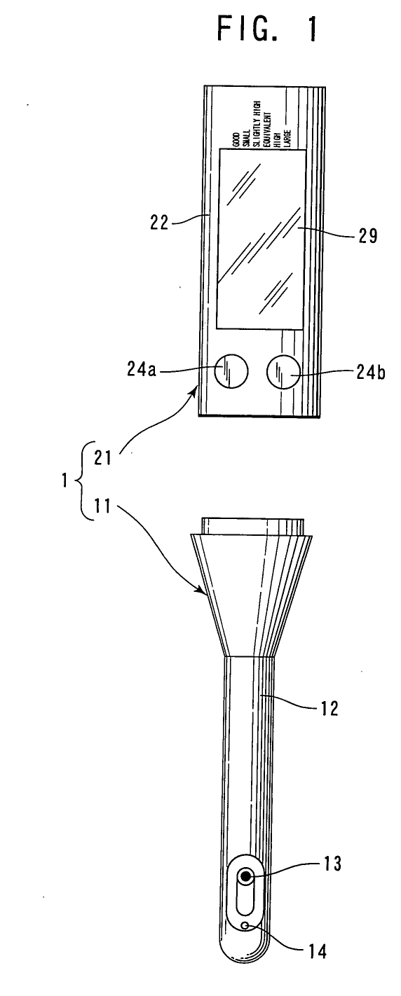

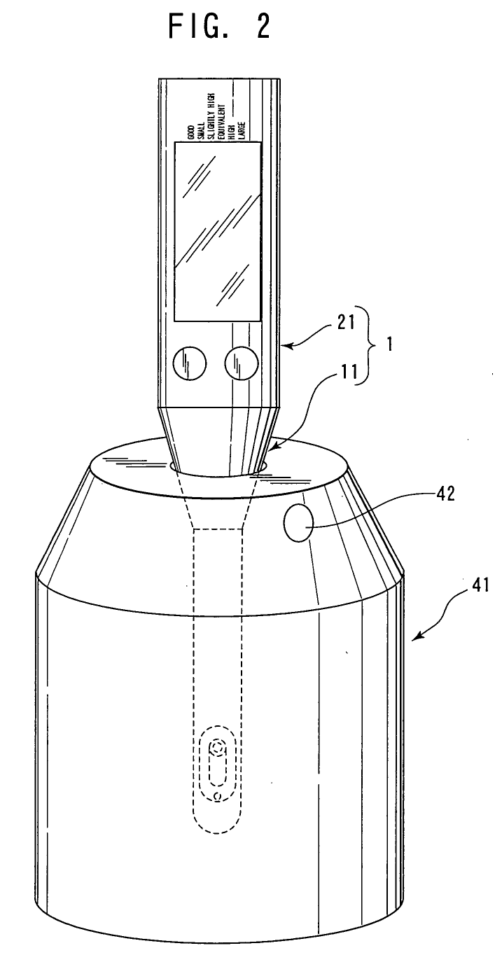

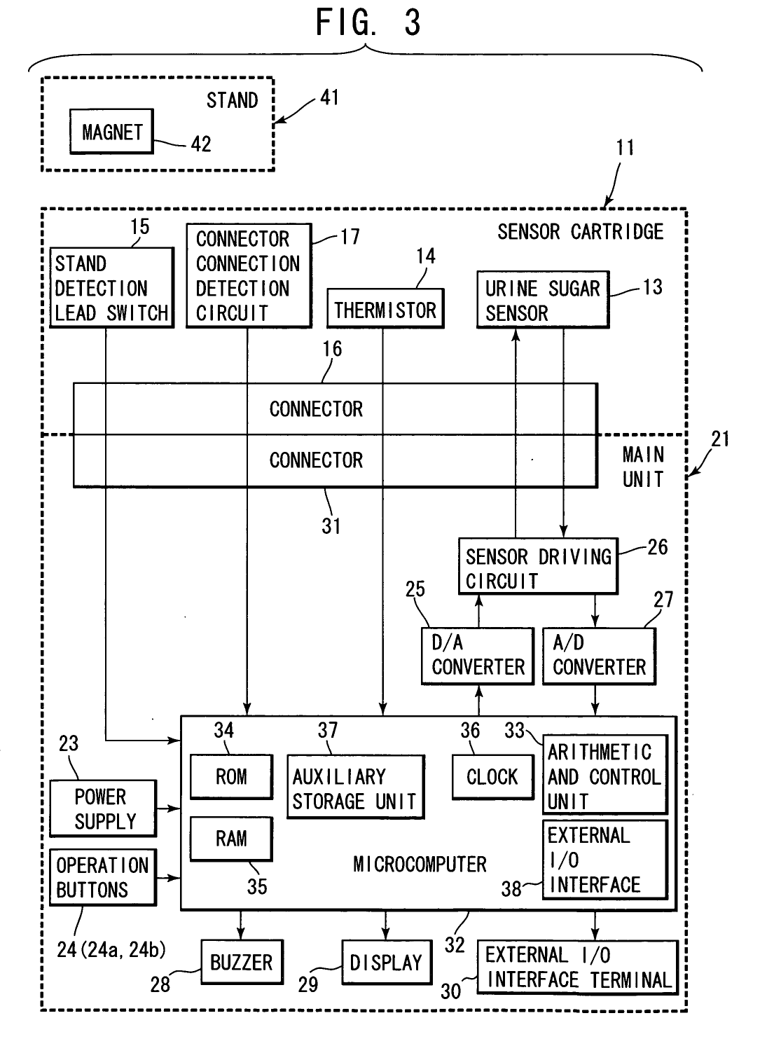

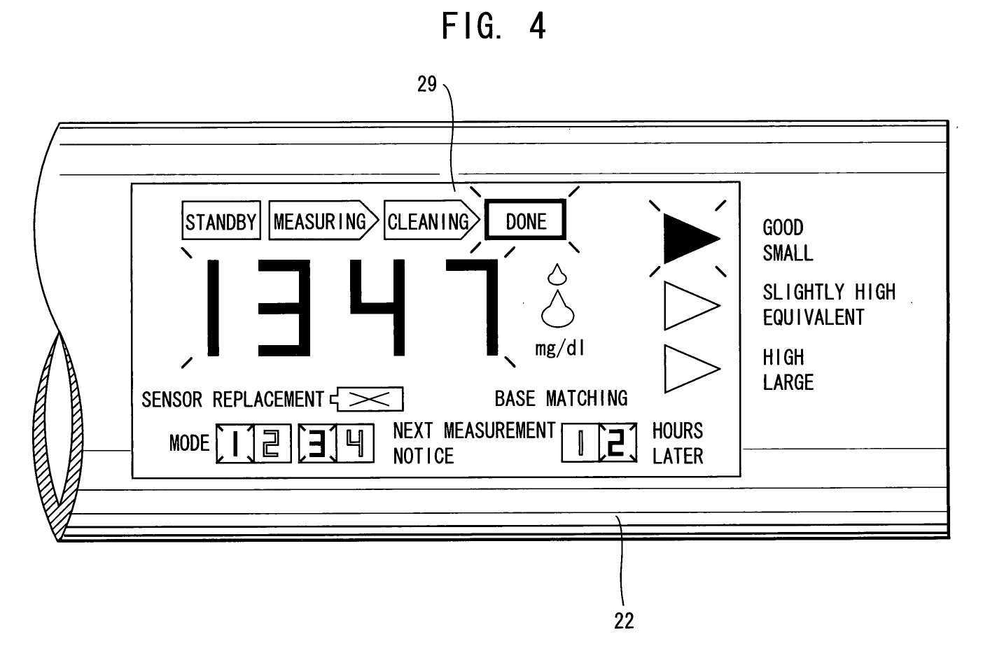

First, the constitution of urine sugar meter according to the present invention will be described in detail by use of external views shown in FIGS. 1 and 2, a block diagram shown in FIG. 3 and a diagram shown in FIG. 4 that illustrates the display form of a display section.

A urine sugar meter 1 according to the present invention roughly comprises a sensor cartridge 11 that detects sugar in the urine electrochemically and a main unit 21 that serves as a grip during measurement and measures and displays the concentration of sugar in the urine based on detection made by the sensor cartridge 11. The urine sugar meter 1 according to the present invention can be inserted and stored in a stand 41 which has a magnet 42 when not used.

The sensor cartridge 11 has a chassis 12. The chassis 12 comprises a urine sugar sensor 13, a thermistor 14, a stand detection lead switch 15, a connector 16, and a connector connection detection circuit 17. Meanwhile, the main unit 21 has a chassis 22. The chassis 22 comprises a power supply 23, operation buttons 24 (24a, 24b), a D/A converter 25, a sensor driving circuit 26, an A/D converter 27, a buzzer 28, a display 29, an external I/O interface terminal 30, a connector 31, and a microcomputer 32.

The urine sugar sensor 13 detects the concentration of sugar in the urine over a wide range without the influence of foreign substances in the urine.

The thermistor 14 detects the temperature of the urine at the time of measurement and corrects the temperature characteristics of the urine sugar sensor 13.

The stand detection lead switch 15 enables mode setting, correction, and measurement of the concentration of sugar in the urine by detecting a change in the strength of a magnetic field in the magnet 42 when the urine sugar meter 1 is taken out of the stand 41.

The power supply 23 is a battery and supplies electric power to each of the sections in the electrical system of the urine sugar meter 1.

The operation buttons 24 (24a and 24b) detect being pressed and are used by a user to select, set and register a mode or a meal menu or correct a meal menu.

The D/A converter 25 converts a digital signal (driving signal) from the microcomputer 32 to an analog signal (driving signal) and outputs the analog signal.

The sensor driving circuit 26 provides a driving signal to the urine sugar sensor 13 based on the driving signal from the D/A converter 25 and inputs and outputs a detection signal detected by the urine sugar sensor 13.

The A/D converter 27 converts the analog signal (detection signal) from the sensor driving circuit 26 to a digital signal (detection signal) and outputs the digital signal.

The buzzer 28 emits a buzzer sound to notify a user of the start of measurement of urine sugar based on a signal from the microcomputer 32.

The display 29 displays the status of correction, the status of measurement, notice of replacement of the sensor, notice of replacement of the battery, the status of selected mode, notice of the next measurement, notice of urine sugar measurement results and notice of determination results, based on a signal from the microcomputer 32. More specifically, the display 29 displays the status of correction by lighting “base matching” and “droplet marks” thereabove out of display items shown in FIG. 4 at the time of correction. Further, the display 29 displays the status of measurement by lighting any of “standby”, “measuring”, “cleaning” and “done” in the measuring process. Further, it displays notice of replacement of the sensor cartridge 11 by lighting “sensor replacement” at the time when the urine sugar sensor 13 is to be replaced. Further, it displays notice of replacement of the battery by lighting “battery mark” at the time when the battery is to be replaced. Further, the display 29 displays the status of selected mode by lighting “mode” and “1”, “2”, “3” or “4” adjacent thereto that corresponds to the selected mode at the time of event. Further, the display 29 displays notice of the next measurement by lighting “next measurement notice” and “hours later”, and “1” or “2” therebetween at the time of event. Further, the display 29 displays notice of urine sugar measurement results by lighting a urine sugar change value, a reference urine sugar change value or a normal urine sugar change value in “4-digit number” after measurement of each of the values. Further, it displays the status of selected mode by lighting one of three “triangle marks” which corresponds to the corresponding determination criteria printed on the chassis 22 after determination of each of the values.

The external I/O interface terminal 30 exchanges various data (i.e. input data from an external device and output data from the urine sugar meter 1 such as urine sugar measurement results and determination results) with an external device such as a personal computer, based on a signal from an external I/O interface 38 in the microcomputer 32.

The connectors 16 and 31 connect the sensor cartridge 11 and the main unit 21 to each other to enable electrical communication therebetween.

The connector connection detection circuit 17 detects whether the connector 16 and the connector 31 are in connection with each other.

The microcomputer 32 comprises an arithmetic and control unit 33, a ROM 34, a RAM 35, a clock 36, an auxiliary storage unit 37, the external I/O interface 38, and IO ports. The arithmetic and control unit 33 computes various urine sugar values and various determinations and is responsible for various controls. The ROM 34 stores programs for control and computations. The RAM 35 temporarily stores computation results, programs read from an external device, and the like. The clock 36 keeps time for various notices. The auxiliary storage unit 37 stores the selected mode, meal menus, various computed urine sugar values and determination results until they are updated. The external I/O interface 38 exchanges various data (i.e. input data from an external device and output data from the urine sugar meter 1 such as urine sugar measurement results and determination results) with an external device such as a personal computer. The IO ports are connected to the sections in the electrical system. The microcomputer 32 notifies a user that an immediately-before-meal urine sugar value, an after-meal urine sugar value, a before-reference-meal urine sugar value, an after-reference-meal urine sugar value, a before-normal-meal urine sugar value and an after-normal-meal urine sugar value should be measured, measures a before-meal urine sugar value, the immediately-before-meal urine sugar value, the after-meal urine sugar value, the before-reference-meal urine sugar value, the immediately-before-meal urine sugar value, the after-reference-meal urine sugar value, the before-normal-meal urine sugar value, an immediately-before-normal-meal urine sugar value and the after-normal-meal urine sugar value, computes a urine sugar change value (difference between the after-meal urine sugar value and the immediately-before-meal urine sugar value), a reference urine sugar change value (difference between the after-reference-meal urine sugar value and the immediately-before-reference-meal urine sugar value), a normal urine sugar change value (difference between the after-normal-meal urine sugar value and the immediately-before-normal-meal urine sugar value) and a meal difference urine sugar change value (difference between the normal urine sugar change value and the reference urine sugar change value), determines a change in sugar amount in a body based on the urine sugar change value and a normal meal menu based on the meal difference urine sugar change value, and controls outputs of the results of these computations and determinations.

The urine sugar sensor 13, D/A converter 25, sensor driving circuit 26, A/D converter 27 and microcomputer 32 constitute before-meal urine sugar measuring means, immediately-before-meal urine sugar measuring means, after-meal urine sugar measuring means, before-reference-meal urine sugar measuring means, immediately-before-reference-meal urine sugar measuring means, after-reference-meal urine sugar measuring means, before-normal-meal urine sugar measuring means, immediately-before-normal-meal urine sugar measuring means, and after-normal-meal urine sugar measuring means. Further, the buzzer 28 and the microcomputer 32 constitute immediately-before-meal urine sugar time signal means, after-meal urine sugar time signal means, immediately-before-reference-meal urine sugar time signal means, after-reference-meal urine sugar time signal means, immediately-before-normal-meal urine sugar time signal means, and after-normal-meal urine sugar time signal means. In addition, the microcomputer 32 constitutes urine sugar change value computing means, sugar amount change determining means, reference urine sugar change value computing means, normal urine sugar change value computing means, meal difference urine sugar change value computing means, and meal menu determining means. Furthermore, the microcomputer 32 and the display 29 or the microcomputer 32 and the external I/O interface terminal 30 constitute urine sugar change data output means and meal difference urine sugar change data output means.

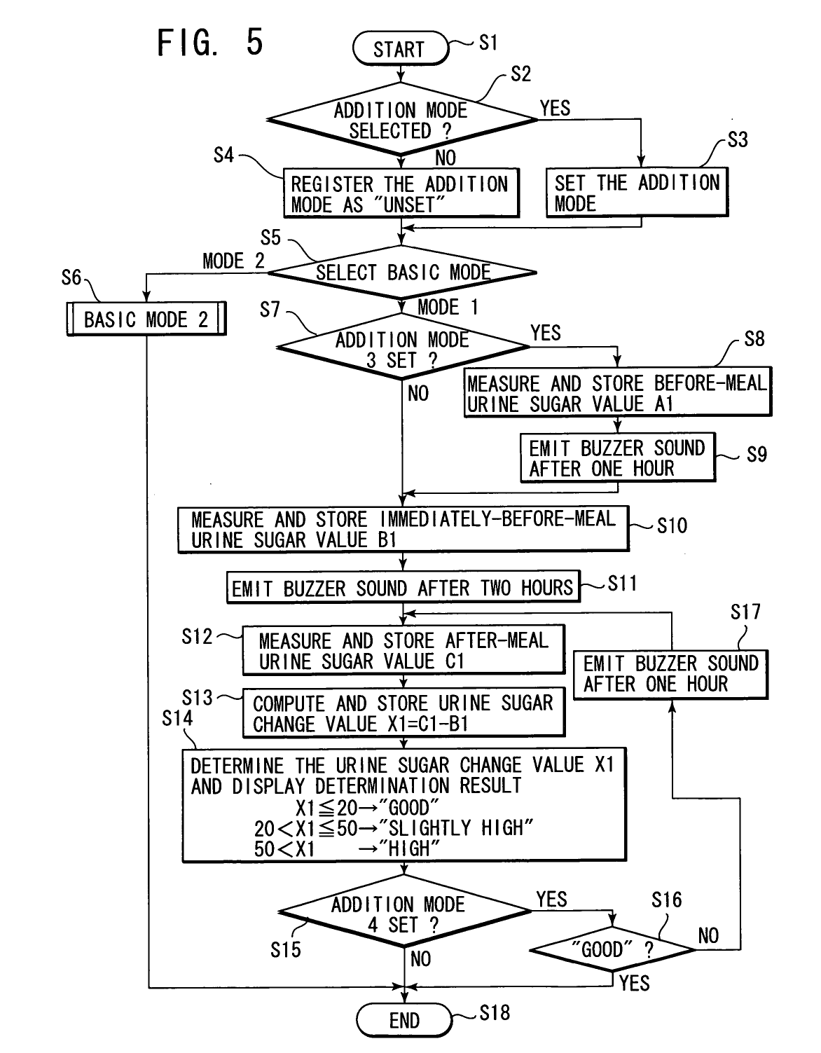

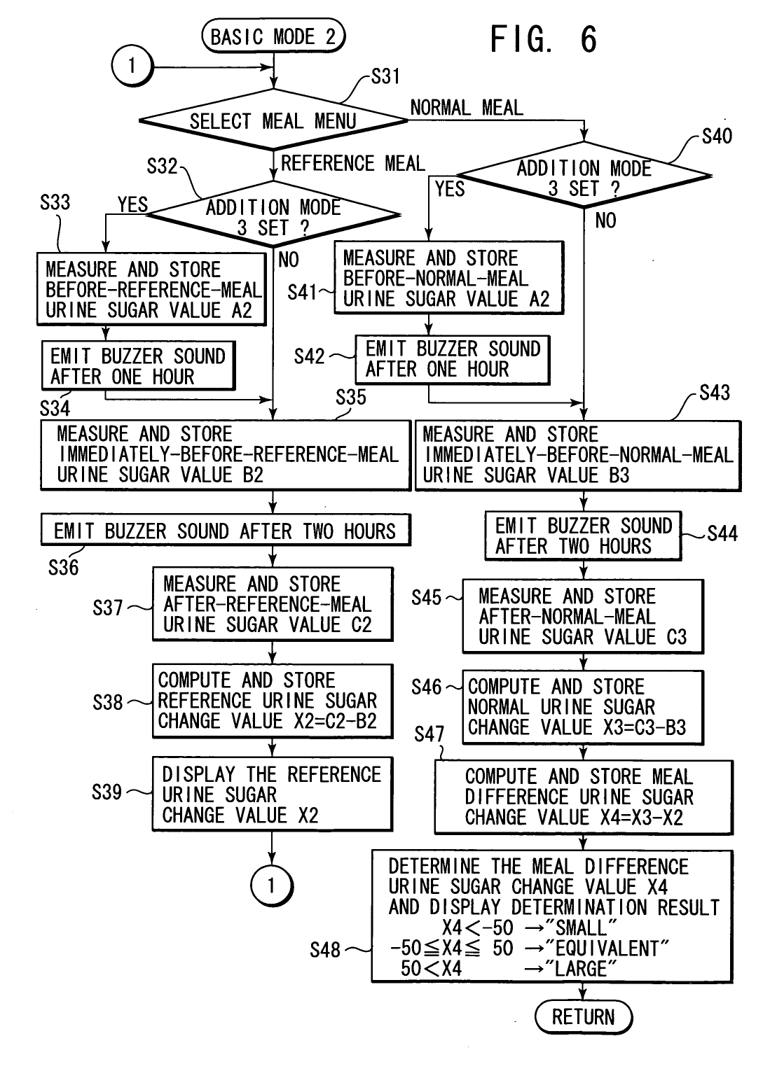

Next, the handling and operation of the urine sugar meter according to the present invention will be described by use of flowcharts shown in FIGS. 5 and 6.

First, when the urine sugar meter 1 is taken out of the stand 41, the stand detection lead switch 15 is activated, and the power supply 23 supplies electric power to the sections in the electrical system, whereby the urine sugar meter 1 is activated (STEP S1).

Then, in the microcomputer 32, it is determined whether an addition mode has been selected by the operation buttons 24 (24a, 24b) (STEP S2). The addition mode refers to a mode 3 (a function for measuring an immediately-before-meal urine sugar value after measuring a before-meal urine sugar value or a function for measuring an immediately-before-reference-meal urine sugar value after measuring a before-reference-meal urine sugar value and an immediately-before-normal-meal urine sugar value after measuring a before-normal-meal urine sugar value) and a mode 4 (a function for measuring an after-meal urine sugar value again depending on the result of measurement of the after-meal urine sugar value).

Then, if the addition mode has been selected by the operation buttons 24 (24a, 24b) (“YES” in STEP S2), this selected addition mode is set and registered, and the mode “3”, mode “4” or modes “3, 4” are lit and displayed on the display 29 (STEP S3). Meanwhile, if the addition mode has not been selected by the operation buttons 24 (24a, 24b) (“NO” in STEP S2), the addition mode is registered as “unset”, and the modes “3” and “4” are turned off on the display 29 (STEP S4).

Then, in the microcomputer 32, it is determined whether a basic mode has been selected by the operation buttons 24 (24a, 24b) (STEP S5). The basic mode refers to a mode 1 (a function for measuring a urine sugar change value and determining acceptability of a change in the amount of sugar in a body) and a mode 2 (a function for measuring a meal difference urine sugar change value and determining acceptability of a normal meal menu).

Then, if the mode 2 has been selected by the operation buttons 24 (24a, 24b) (“mode 2” in STEP S5), the selected mode 2 is set and registered, the mode “2” is lit and displayed on the display 29, and the microcomputer 32 proceeds to STEP S6 which will be described later. Meanwhile, if the mode 1 has been selected by the operation buttons 24 (24a, 24b) (“mode 1” in STEP S5), the selected mode 1 is set and registered, the mode “1” is lit and displayed on the display 29, and it is then determined in the microcomputer 32 whether the mode 3 has been set (STEP S7).

Then, if the mode 3 has been set (“YES” in STEP S7), a sugar component in the urine is detected by the urine sugar sensor 13, a detection signal which has passed through the sensor driving circuit 26 and the A/D converter 27 is taken in by the microcomputer 32, this detection signal is computed as a before-meal urine sugar value A1 by the arithmetic and control unit 33, this before-meal urine sugar value A1 is stored in the auxiliary storage unit 37, and the next measurement notice “1” hour later is lit and displayed on the display 29 (STEP S8). Then, after one hour is timed by the clock 36, the buzzer 28 emits a buzzer sound to notify a subject that immediately-before-meal urine sugar will be measured (STEP S9).

Meanwhile, if the mode 3 has not been set (“NO” in STEP S7) or after STEP S9, a sugar component in the urine is detected by the urine sugar sensor 13, a detection signal which has passed through the sensor driving circuit 26 and the A/D converter 27 is taken in by the microcomputer 32, this detection signal is computed as an immediately-before-meal urine sugar value B1 by the arithmetic and control unit 33, this immediately-before-meal urine sugar value B1 is stored in the auxiliary storage unit 37, and the next measurement notice “2” hours later is lit and displayed on the display 29 (STEP S10). Immediately after measurement of the immediately-before-meal urine sugar value B1, the subject has a meal. Then, after two hours are timed by the clock 36, the buzzer 28 emits a buzzer sound to notify the subject that after-meal urine sugar will be measured (STEP S11).

Then, a sugar component in the urine is detected by the urine sugar sensor 13, a detection signal which has passed through the sensor driving circuit 26 and the A/D converter 27 is taken in by the microcomputer 32, this detection signal is computed as an after-meal urine sugar value C1 by the arithmetic and control unit 33, and this after-meal urine sugar value C1 is stored in the auxiliary storage unit 37 (STEP S12).

Then, the difference between the after-meal urine sugar value C1 and the immediately-before-meal urine sugar value B1 is computed as a urine sugar change value X1 by the arithmetic and control unit 33, and this urine sugar change value X1 is stored in the auxiliary storage unit 37 (STEP S13).

Then, in the arithmetic and control unit 33, the computed urine sugar change value X1 is determined to be “good” when it is not larger than 20 mg/dl, “slightly high” when larger than 20 mg/dl but not larger than 50 mg/dl and “high” when larger than 50 mg/dl, and this determination result is stored in the auxiliary storage unit 37. Then, the urine sugar change value X1 and the determination result (i.e. a “triangle mark” corresponding to the corresponding determination criteria printed on the chassis 22) are displayed on the display 29 and output by the external I/O interface terminal 30 (STEP S14).

Then, in the microcomputer 32, it is determined whether the mode 4 has been set (STEP S15). Then, if the mode 4 has been set (“YES” in STEP S15), it is determined whether the foregoing determination result is “good” (STEP S16). Then, if the foregoing determination result is not “good” (“NO” in STEP S16), the next measurement notice “1” hour later is lit and displayed on the display 29, the buzzer 28 emits a buzzer sound to notify the subject that the after-meal urine sugar will be measured again after one hour is timed by the clock 36 (STEP S17), and the microcomputer returns to STEP S12 to repeat the steps.

Meanwhile, if the mode 4 has not been set (“NO” in STEP S15) or if the foregoing determination result is “good” (“YES” in STEP S16), this series of steps are ended (STEP S18).

Next, the case where the microcomputer 32 has proceeded to STEP S6 (i.e. the mode 2 has been selected by the operation buttons 24 (24a, 24b)) in the above series of steps will be described.

If the mode 2 has been selected by the operation buttons 24 (24a, 24b) (“mode 2” in STEP S5), it is determined in the microcomputer 32 whether a meal menu (reference meal or normal meal) has been selected by the operation buttons 24 (24a, 24b) (STEP S31). More specifically, the microcomputer 32 selects the reference meal when the operation button 24a is pressed and selects the normal meal when the operation button 24b is pressed.

Then, if the reference meal has been selected (“reference meal” in STEP S31), it is determined whether the mode 3 has been set (STEP S32).

Then, if the mode 3 has been set (“YES” in STEP S32), a sugar component in the urine is detected by the urine sugar sensor 13, a detection signal which has passed through the sensor driving circuit 26 and the A/D converter 27 is taken in by the microcomputer 32, this detection signal is computed as a before-reference-meal urine sugar value A2 by the arithmetic and control unit 33, this before-reference-meal urine sugar value A2 is stored in the auxiliary storage unit 37, and the next measurement notice “1” hour later is lit and displayed on the display 29 (STEP S33). Then, after one hour is timed by the clock 36, the buzzer 28 emits a buzzer sound to notify the subject that immediately-before-reference-meal urine sugar will be measured (STEP S34).

Meanwhile, if the mode 3 has not been set (“NO” in STEP S32) or after STEP S34, a sugar component in the urine is detected by the urine sugar sensor 13, a detection signal which has passed through the sensor driving circuit 26 and the A/D converter 27 is taken in by the microcomputer 32, this detection signal is computed as an immediately-before-reference-meal urine sugar value B2 by the arithmetic and control unit 33, this immediately-before-reference-meal urine sugar value B2 is stored in the auxiliary storage unit 37, and the next measurement notice “2” hours later is lit and displayed on the display 29 (STEP S35). Immediately after measurement of the immediately-before-reference-meal urine sugar value B2, the subject has a reference meal. Then, after two hours are timed by the clock 36, the buzzer 28 emits a buzzer sound to notify the subject that after-reference-meal urine sugar will be measured (STEP S36).

Then, a sugar component in the urine is detected by the urine sugar sensor 13, a detection signal which has passed through the sensor driving circuit 26 and the A/D converter 27 is taken in by the microcomputer 32, this detection signal is computed as an after-reference-meal urine sugar value C2 by the arithmetic and control unit 33, and this after-reference-meal urine sugar value C2 is stored in the auxiliary storage unit 37 (STEP S37).

Then, the difference between the after-reference-meal urine sugar value C2 and the immediately-before-reference-meal urine sugar value B2 is computed as a reference urine sugar change value X2 by the arithmetic and control unit 33, and this reference urine sugar change value X2 is stored in the auxiliary storage unit 37 (STEP S38) and displayed on the display 29 (STEP S39).

Meanwhile, if the normal meal has been selected (“normal meal” in STEP S31), it is determined whether the mode 3 has been set (STEP S40).

Then, if the mode 3 has been set (“YES” in STEP S40), a sugar component in the urine is detected by the urine sugar sensor 13, a detection signal which has passed through the sensor driving circuit 26 and the A/D converter 27 is taken in by the microcomputer 32, this detection signal is computed as a before-normal-meal urine sugar value A3 by the arithmetic and control unit 33, this before-normal-meal urine sugar value A3 is stored in the auxiliary storage unit 37, and the next measurement notice “1” hour later is lit and displayed on the display 29 (STEP S41). Then, after one hour is timed by the clock 36, the buzzer 28 emits a buzzer sound to notify the subject that immediately-before-normal-meal urine sugar will be measured (STEP S42).

Meanwhile, if the mode 3 has not been set (“NO” in STEP S40) or after STEP S42, a sugar component in the urine is detected by the urine sugar sensor 13, a detection signal which has passed through the sensor driving circuit 26 and the A/D converter 27 is taken in by the microcomputer 32, this detection signal is computed as an immediately-before-normal-meal urine sugar value B3 by the arithmetic and control unit 33, this immediately-before-normal-meal urine sugar value B3 is stored in the auxiliary storage unit 37, and the next measurement notice “2” hours later is lit and displayed on the display 29 (STEP S43). Immediately after measurement of the immediately-before-normal-meal urine sugar value B3, the subject has a normal meal. Then, after two hours are timed by the clock 36, the buzzer 28 emits a buzzer sound to notify the subject that after-normal-meal urine sugar will be measured (STEP S44).

Then, a sugar component in the urine is detected by the urine sugar sensor 13, a detection signal which has passed through the sensor driving circuit 26 and the A/D converter 27 is taken in by the microcomputer 32, this detection signal is computed as an after-normal-meal urine sugar value C3 by the arithmetic and control unit 33, and this after-normal-meal urine sugar value C3 is stored in the auxiliary storage unit 37 (STEP S45).

Then, the difference between the after-normal-meal urine sugar value C3 and the immediately-before-normal-meal urine sugar value B3 is computed as a normal urine sugar change value X3 by the arithmetic and control unit 33, and this normal urine sugar change value X3 is stored in the auxiliary storage unit 37 (STEP S46).

Then, the difference between the normal urine sugar change value X3 and the reference urine sugar change value X2 is computed as a meal difference urine sugar change value X4 by the arithmetic and control unit 33, and this meal difference urine sugar change value X4 is stored in the auxiliary storage unit 37 (STEP S47).

Then, in the arithmetic and control unit 33, the normal meal menu is determined to be “small” when the meal difference urine sugar change value X4 is smaller than −50 mg/dl, “equivalent” when the meal difference urine sugar change value X4 is not smaller than −50 mg/dl and not larger than 50 mg/dl and “large” when the meal difference urine sugar change value X4 is larger than 50 mg/dl, and this determination result is stored in the auxiliary storage unit 37. Then, the meal difference urine sugar change value X4 and the determination result (i.e. a “triangle mark” corresponding to the corresponding determination criteria printed on the chassis 22) are displayed on the display 29 and output by the external I/O interface terminal 30 (STEP S18). Then, the microcomputer 32 exits the mode 2 and ends the above series of steps (STEP S18).

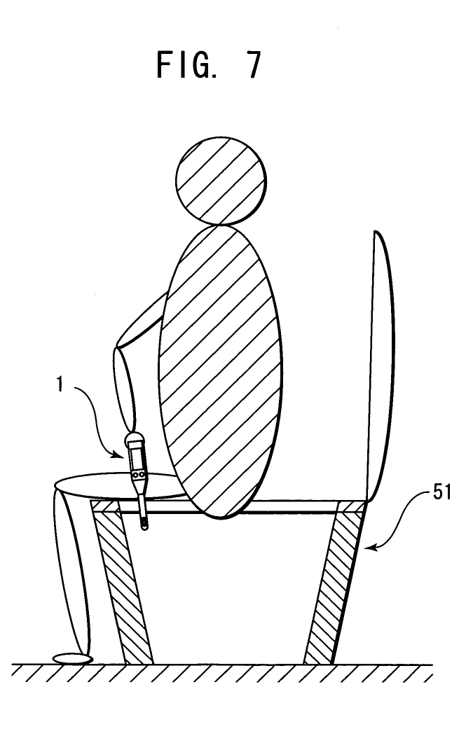

The above before-meal, immediately-before-meal, after-meal, before-reference-meal, immediately-before-reference-meal, after-reference-meal, before-normal-meal, immediately-before-normal-meal and after-normal-meal urine sugar measurements are carried out in such a manner that a subject holds the urine sugar meter 1 in a hand and applies urine to the urine sugar sensor 13 portion in a toilet 51 as shown in FIG. 7 or that urine is collected in a container 52, and a subject holds the urine sugar meter 1 in a hand and immerses the urine sugar sensor 13 portion in the urine as shown in FIG. 9.

An embodiment of the urine sugar meter according to the present invention has been specifically described above. Alternatively, the urine sugar meter of the present invention may be constituted that meal data is input by the operation buttons, stored continuously in the auxiliary storage unit 37 and later retrieved or searched as texts or images.

What is claimed is:

1. A urine sugar meter comprising:
immediately-before-meal urine sugar measuring means,
after-meal urine sugar time signal means,
after-meal urine sugar measuring means,
urine sugar change value computing means, and
urine sugar change data output means,
wherein
the immediately-before-meal urine sugar measuring means measures an immediately-before-meal urine sugar value,
the after-meal urine sugar time signal means notifies a subject that an after-meal urine sugar value should be measured after passage of a predetermined time from measurement of the immediately-before-meal urine sugar value by the immediately-before-meal urine sugar measuring means,
the after-meal urine sugar measuring means measures the after-meal urine sugar value after notification by the after-meal urine sugar time signal means,
the urine sugar change value computing means computes the difference between the after-meal urine sugar value measured by the after-meal urine sugar measuring means and the immediately-before-meal urine sugar value measured by the immediately-before-meal urine sugar measuring means as a urine sugar change value, and
the urine sugar change data output means outputs the urine sugar change value computed by the urine sugar change value computing means.

2. The urine sugar meter of claim 1, wherein the predetermined time elapsed from measurement of the immediately-before-meal urine sugar value is two hours.

3. The urine sugar meter of claim 1, further comprising:
sugar amount change acceptability determining means,
wherein
the sugar amount change acceptability determining means determines acceptability of a change in the amount of sugar in a body based on the urine sugar change value computed by the urine sugar change value computing means, and
the urine sugar change data output means also outputs an indicator about the acceptability of the change in the amount of sugar in the body determined by the sugar amount change acceptability determining means.

4. The urine sugar meter of claim 2, further comprising:
sugar amount change acceptability determining means,
wherein
the sugar amount change acceptability determining means determines acceptability of a change in the amount of sugar in a body based on the urine sugar change value computed by the urine sugar change value computing means, and
the urine sugar change data output means also outputs an indicator about the acceptability of the change in the amount of sugar in the body determined by the sugar amount change acceptability determining means.

5. The urine sugar meter of claim 3, wherein the sugar amount change acceptability determining means determines that the change in the amount of sugar in the body is “good” which means “acceptable” when the urine sugar change value is not larger than 20 mg/dl, “slightly high” which means “unacceptable” when the urine sugar change value is larger than 20 mg/dl but not larger than 50 mg/dl and “high” which means “unacceptable” when the urine sugar change value is larger than 50 mg/dl.

6. The urine sugar meter of claim 4, wherein the sugar amount change acceptability determining means determines that the change in the amount of sugar in the body is “good” which means “acceptable” when the urine sugar change value is not larger than 20 mg/dl, “slightly high” which means “unacceptable” when the urine sugar change value is larger than 20 mg/dl but not larger than 50 mg/dl and “high” which means “unacceptable” when the urine sugar change value is larger than 50 mg/dl.

7. The urine sugar meter of claim 3, wherein the after-meal urine sugar time signal means also notifies the subject that the after-meal urine sugar value should be remeasured after passage of a predetermined time from measurement of the after-meal urine sugar value by the after-meal urine sugar measuring means, when the change in the amount of sugar in the body which has been determined by the sugar amount change acceptability determining means is unacceptable.

8. The urine sugar meter of claim 4, wherein the after-meal urine sugar time signal means also notifies the subject that the after-meal urine sugar value should be remeasured after passage of a predetermined time from measurement of the after-meal urine sugar value by the after-meal urine sugar measuring means, when the change in the amount of sugar in the body which has been determined by the sugar amount change acceptability determining means is unacceptable.

9. The urine sugar meter of claim 5, wherein the after-meal urine sugar time signal means also notifies the subject that the after-meal urine sugar value should be remeasured after passage of a predetermined time from measurement of the after-meal urine sugar value by the after-meal urine sugar measuring means, when the change in the amount of sugar in the body which has been determined by the sugar amount change acceptability determining means is unacceptable.

10. The urine sugar meter of claim 6, wherein the after-meal urine sugar time signal means also notifies the subject that the after-meal urine sugar value should be remeasured after passage of a predetermined time from measurement of the after-meal urine sugar value by the after-meal urine sugar measuring means, when the change in the amount of sugar in the body which has been determined by the sugar amount change acceptability determining means is unacceptable.

11. The urine sugar meter of claim 7, wherein the predetermined time elapsed from measurement of the after-meal urine sugar value is one hour.

12. The urine sugar meter of claim 8, wherein the predetermined time elapsed from measurement of the after-meal urine sugar value is one hour.

13. The urine sugar meter of claim 9, wherein the predetermined time elapsed from measurement of the after-meal urine sugar value is one hour.

14. The urine sugar meter of claim 10, wherein the predetermined time elapsed from measurement of the after-meal urine sugar value is one hour.

15. The urine sugar meter of any one of claims 1 to 14, further comprising:
before-meal urine sugar measuring means, and
immediately-before-meal urine sugar time signal means,
wherein
the before-meal urine sugar measuring means measures a before-meal urine sugar value before measurement of the immediately-before-meal urine sugar value by the immediately-before-meal urine sugar measuring means, and
the immediately-before-meal urine sugar time signal means notifies the subject that the immediately-before-meal urine sugar value should be measured after passage of a predetermined time from measurement of the before-meal urine sugar value by the before-meal urine sugar measuring means.

16. The urine sugar meter of claim 15, wherein the predetermined time elapsed from measurement of the before-meal urine sugar value is one hour.

17. A urine sugar meter comprising:
immediately-before-reference-meal urine sugar measuring means,
after-reference-meal urine sugar time signal means,
after-reference-meal urine sugar measuring means,
reference urine sugar change value computing means,
immediately-before-normal-meal urine sugar measuring means,
after-normal-meal urine sugar time signal means,
after-normal-meal urine sugar measuring means,
normal urine sugar change value computing means,
meal difference urine sugar change value computing means, and
meal difference urine sugar change data output means,
wherein
the immediately-before-reference-meal urine sugar measuring means measures an immediately-before-reference-meal urine sugar value,
the after-reference-meal urine sugar time signal means notifies a subject that an after-reference-meal urine sugar value should be measured after passage of a predetermined time from measurement of the immediately-before-reference-meal urine sugar value by the immediately-before-reference-meal urine sugar measuring means,
the after-reference-meal urine sugar measuring means measures the after-reference-meal urine sugar value after notification by the after-reference-meal urine sugar time signal means,
the reference urine sugar change value computing means computes the difference between the after-reference-meal urine sugar value measured by the after-reference-meal urine sugar measuring means and the immediately-before-reference-meal urine sugar value measured by the immediately-before-reference-meal urine sugar measuring means as a reference urine sugar change value,
the immediately-before-normal-meal urine sugar measuring means measures an immediately-before-normal-meal urine sugar value,
the after-normal-meal urine sugar time signal means notifies the subject that an after-normal-meal urine sugar value should be measured after passage of a predetermined time from measurement of the immediately-before-normal-meal urine sugar value by the immediately-before-normal-meal urine sugar measuring means,
the after-normal-meal urine sugar measuring means measures the after-normal-meal urine sugar value after notification by the after-normal-meal urine sugar time signal means,
the normal urine sugar change value computing means computes the difference between the after-normal-meal urine sugar value measured by the after-normal-meal urine sugar measuring means and the immediately-before-normal-meal urine sugar value measured by the immediately-before-normal-meal urine sugar measuring means as a normal urine sugar change value,
the meal difference urine sugar change value computing means computes the difference between the normal urine sugar change value computed by the normal urine sugar change value computing means and the reference urine sugar change value computed by the reference urine sugar change value computing means as a meal difference urine sugar change value, and
the meal difference urine sugar change data output means outputs the meal difference urine sugar change value computed by the meal difference urine sugar change value computing means.

18. The urine sugar meter of claim 17, wherein the predetermined time elapsed from measurement of the immediately-before-reference-meal urine sugar value is two hours, and the predetermined time elapsed from measurement of the immediately-before-normal-meal urine sugar value is two hours.

19. The urine sugar meter of claim 17, further comprising:
meal menu acceptability determining means,
wherein
the meal menu acceptability determining means determines acceptability of a normal meal menu based on the meal difference urine sugar change value computed by the meal difference urine sugar change value computing means, and
the meal difference urine sugar change data output means also outputs an indicator about the acceptability of the normal meal menu determined by the meal menu acceptability determining means.

20. The urine sugar meter of claim 18, further comprising:
meal menu acceptability determining means,
wherein
the meal menu acceptability determining means determines acceptability of a normal meal menu based on the meal difference urine sugar change value computed by the meal difference urine sugar change value computing means, and
the meal difference urine sugar change data output means also outputs an indicator about the acceptability of the normal meal menu determined by the meal menu acceptability determining means.

21. The urine sugar meter of claim 19, wherein the meal menu acceptability determining means determines that the normal meal menu is “small” which means “acceptable” when the meal difference urine sugar change value is smaller than −50 mg/dl, “equivalent” which means “unacceptable” when the meal difference urine sugar change value is not smaller than −50 mg/dl and not larger than 50 mg/dl and “large” which means “unacceptable” when the meal difference urine sugar change value is larger than 50 mg/dl.

22. The urine sugar meter of claim 20, wherein the meal menu acceptability determining means determines that the normal meal menu is “small” which means “acceptable” when the meal difference urine sugar change value is smaller than −50 mg/dl, “equivalent” which means “unacceptable” when the meal difference urine sugar change value is not smaller than −50 mg/dl and not larger than 50 mg/dl and “large” which means “unacceptable” when the meal difference urine sugar change value is larger than 50 mg/dl.

23. The urine sugar meter of any one of claims 17 to 22, further comprising:
before-reference-meal urine sugar measuring means,
immediately-before-reference-meal urine sugar time signal means,
before-normal-meal urine sugar measuring means, and
immediately-before-normal-meal urine sugar time signal means,
wherein
the before-reference-meal urine sugar measuring means measures a before-reference-meal urine sugar value before measurement of the immediately-before-reference-meal urine sugar value by the immediately-before-reference-meal urine sugar measuring means,
the immediately-before-reference-meal urine sugar time signal means notifies the subject that the immediately-before-reference-meal urine sugar value should be measured after passage of a predetermined time from measurement of the before-reference-meal urine sugar value by the before-reference-meal urine sugar measuring means,
the before-normal-meal urine sugar measuring means measures a before-normal-meal urine sugar value before measurement of the immediately-before-normal-meal urine sugar value by the immediately-before-normal-meal urine sugar measuring means, and
the immediately-before-normal-meal urine sugar time signal means notifies the subject that the immediately-before-normal-meal urine sugar value should be measured after passage of a predetermined time from measurement of the before-normal-meal urine sugar value by the before-normal-meal urine sugar measuring means.

24. The urine sugar meter of claim 23, wherein the predetermined time elapsed from measurement of the before-reference-meal urine sugar value is one hour, and the predetermined time elapsed from measurement of the before-normal-meal urine sugar value is one hour.
